(19) United States
(12) Patent Application Publication
(10) Pub. No.: US 2024/0351259 A1
(43) Pub. Date: Oct. 24, 2024

(54) VALVE ASSEMBLY FOR AN INJECTION MOLDING SYSTEM

(71) Applicant: MOLD-MASTERS (2007) LIMITED, Georgetown (CA)

(72) Inventor: Payman Tabassi, Rockwood (CA)

(73) Assignee: MOLD-MASTERS (2007) LIMITED, Georgetown, ON (CA)

(21) Appl. No.: 18/135,984

(22) Filed: Apr. 18, 2023

(51) Int. Cl. B29C 45/30; B29C 45/28

(52) U.S. Cl. CPC B29C 45/30; B29C 45/28; B29C 2045/306

(57) ABSTRACT

Valve assemblies according to the present disclosure include a channel with a channel proximal end and a channel distal end. The valve assemblies also include and an inlet that receives a nozzle at an inlet proximal end that injects a molten plastic into the channel. The inlet includes a first inlet surface at an inlet distal end fluidly coupled to the channel. The valve assemblies further include a valve translatably coupled to the channel and the valve translates between an open position and a closed position. The valve includes a valve proximal end, a valve distal end, and a first valve surface at the valve proximal end. A diameter seal is formed between the first inlet surface of the inlet and the first valve surface of the valve when the valve is translated from the open position to the closed position.

### FIELD

The embodiments described herein generally relate to a valve assembly, and more particularly, to a valve assembly for an injection molding system.

### BACKGROUND

Injection molding systems utilize an injector to inject molten plastic through a manifold inlet into a manifold. However, some molten plastic may leak out from the manifold when the injector is decoupled from the manifold inlet.

### SUMMARY

In one embodiment, a valve assembly for an injection molding system is provided. The valve assembly includes a channel including a channel proximal end and a channel distal end. Also included is an inlet including a first inlet surface at an inlet distal end fluidly coupled to the channel at the channel proximal end. The inlet couples to a nozzle at an inlet proximal end that injects a molten plastic into the channel. The valve assembly also includes a valve translatably coupled to the channel. The valve translates between an open position and a closed position. The valve includes a valve proximal end, a valve distal end, and a first valve surface at the valve proximal end. A diameter seal is formed between the first inlet surface of the inlet and the first valve surface of the valve when the valve is translated from the open position to the closed position.

In another embodiment, an injection molding system is provided. The injection molding system includes a channel including a channel proximal end and a channel distal end, an injector including a nozzle, and an inlet including a first inlet surface at an inlet distal end fluidly coupled to the channel at the channel proximal end. The inlet couples to the nozzle at an inlet proximal end that injects a molten plastic into the channel. The injection molding system also includes a valve translatably coupled the channel. The valve translates between an open position and a closed position. The valve includes at least one groove, at least one fin, a valve proximal end, a valve distal end, and a first valve surface at the valve proximal end. The valve translates from the open position to the closed position and a diameter seal is formed between the first inlet surface of the inlet and the first valve surface of the valve.

In yet another embodiment, an injection molding system is provided. The injection molding system includes a channel including a channel proximal end and a channel distal end, an injector including a nozzle, and an inlet including a first inlet surface at an inlet distal end fluidly coupled to the channel at the channel proximal end. The inlet couples to the nozzle at an inlet proximal end that injects a molten plastic into the channel. The injection molding system also includes a valve translatably coupled the channel. The valve translates between an open position and a closed position. The valve includes at least one groove, at least one fin, a valve proximal end, a valve distal end, a valve diameter surface at the valve proximal end, and a valve tapered surface at the valve proximal end. The valve translates from the open position to the closed position and a diameter seal is formed between the first inlet surface of the inlet and the valve diameter surface of the valve, and a taper seal is formed between the inlet tapered surface of the inlet and the valve tapered surface of the valve.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

FIG. 1 depicts an injection molding system, according to one or more embodiments illustrated and described herein;

FIG. 2 depicts a partial cross-sectional view of a valve assembly of the injection molding system of FIG. 1 in an open position, according to one or more embodiments illustrated and described herein;

FIG. 3 depicts a partial cross-sectional view of the valve assembly of FIG. 2 in a closed position, according to one or more embodiments illustrated and described herein;

FIG. 4A depicts a perspective view of a valve of the valve assembly of FIGS. 2-3, according to one or more embodiments illustrated and described herein;

FIG. 4B depicts a perspective view of the valve assembly of FIGS. 2-3, according to one or more embodiments illustrated and described herein;

FIG. 5 depicts a partial cross-sectional view of another embodiment of the valve assembly of FIGS. 2-3, according to one or more embodiments illustrated and described herein; and

FIG. 6 depicts a partial cross-sectional view of the valve assembly of FIG. 5, according to one or more embodiments illustrated and described herein.

### DETAILED DESCRIPTION

Embodiments described herein are generally directed to valve assemblies, injection molding systems, and methods for delivering molten plastic. In some embodiments, a valve assembly includes a channel having a channel proximal end and a channel distal end. The valve assembly may also include an inlet having a first inlet surface at an inlet distal end fluidly coupled to the channel at the channel proximal end. The inlet couples to a nozzle at an inlet proximal end that injects a molten plastic into the channel. A valve is translatably coupled to the channel. The valve translates between an open position and a closed position. The valve includes a valve proximal end, a valve distal end, and a first valve surface at the valve proximal end. A diameter seal is formed between the first inlet surface of the inlet and the first valve surface of the valve when the valve is translated from the open position to the closed position. Various embodiments of valve assemblies, injection molding systems, and methods for delivering plastic will now be described in detail with reference to the drawings.

To create the seal between the valve and the inlet, the valve may be translated from the open position to the closed position. The valve may then create a seal between a first inlet surface of the inlet and a first valve surface of the valve.

As used throughout the present disclosure, the terms “upstream” and “downstream” refer to the relative positioning of unit operations with respect to the direction of flow of the process streams. A first unit operation of a system may be considered “upstream” of a second unit operation if process streams flowing through the system encounter the first unit operation before encountering the second unit operation. Likewise, a second unit operation may be considered “downstream” of the first unit operation if the process streams flowing through the system encounter the first unit operation before encountering the second unit operation.

As used throughout the present disclosure, the term “diameter surface” refers to a perimeter surface of a substantially cylindrically shaped portion of an object.

As used throughout the present disclosure, the term “diameter seal” refers to an engagement between two diameter surfaces.

As used throughout the present disclosure, the term “tapered surface” refers to an angled surface.

As used throughout the present disclosure, the term “taper seal” refers to an engagement between two tapered surfaces.

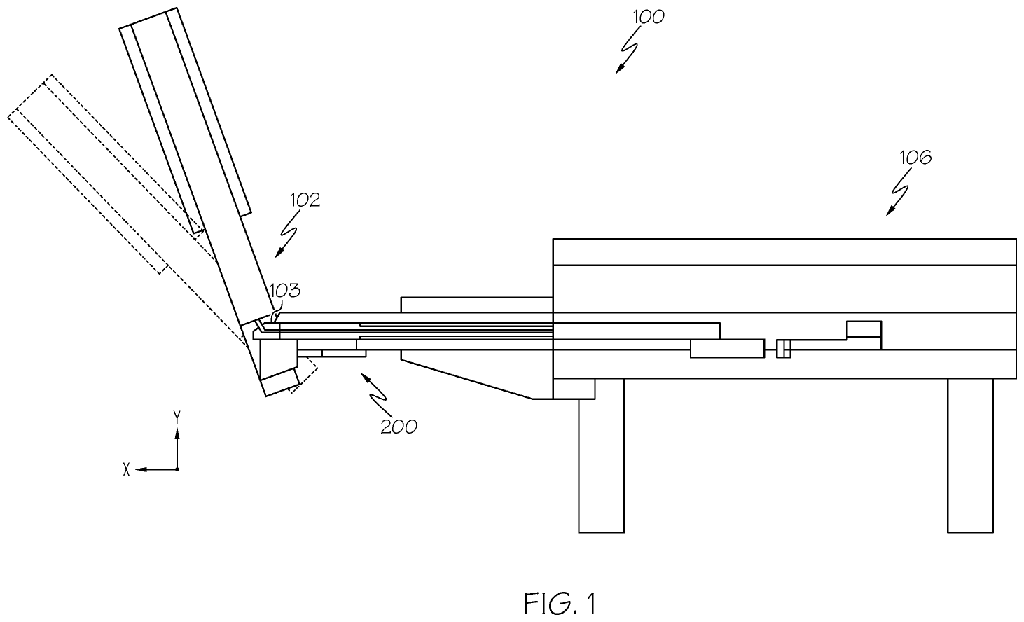

FIG. 1 depicts an injection molding system 100. The injection molding system 100 includes an injector 102, a nozzle 103, a manifold 106, and a valve assembly 200. In these embodiments, the injector 102 may be a molten plastic injector configured to inject molten plastic into the manifold 106.

The injection molding system 100 may be configured to inject the molten plastic into the manifold 106 by heating the molten plastic in the injector 102, injecting the molten plastic into the valve assembly 200 through the nozzle 103. In the illustrated embodiment, the valve assembly 200 is external to the manifold 106 but a person of ordinary skill in the art would appreciate that the valve assembly 200 may also be partially or fully be in the manifold 106.

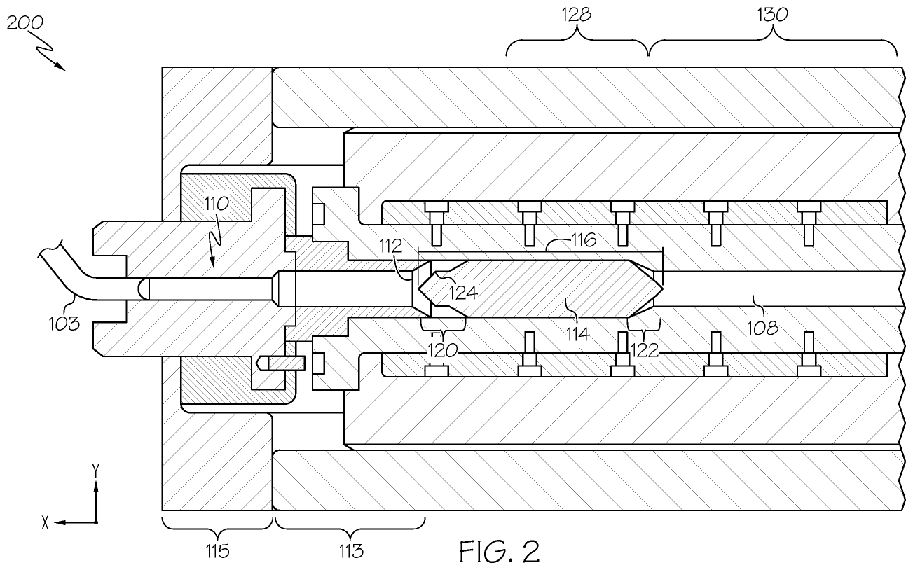

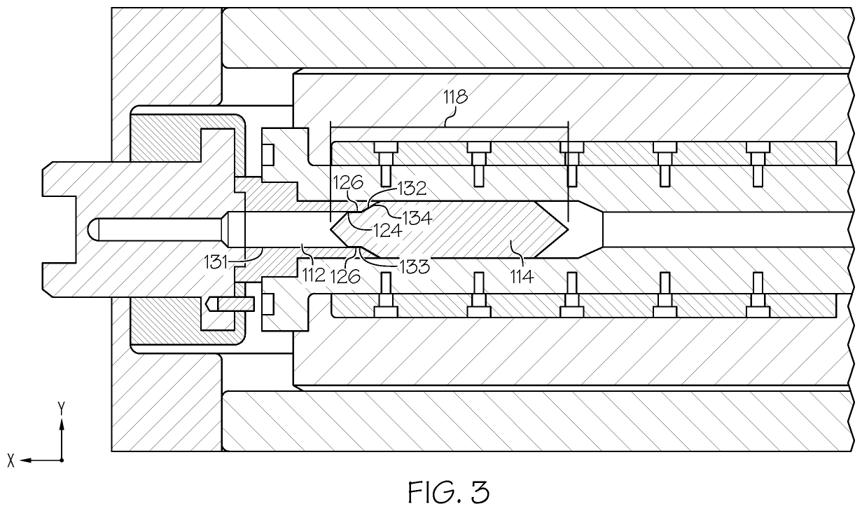

Referring now to FIGS. 2 and 3, the valve assembly 200 is depicted. In these embodiments, the valve assembly 200 may include a channel 108, an inlet 110, and a valve 114. The channel 108 includes a channel proximal end 128 and a channel distal end 130. The inlet includes a first inlet surface 112 at an inlet distal end 113 that is fluidly coupled to the channel 108 at the channel proximal end 128. The inlet 110 receives the nozzle 103 at an inlet proximal end 115 and injects the molten plastic into the channel 108. The valve 114 is translatably coupled to the channel 108. The valve 114 translates between an open position 116, in which molten plastic may flow from upstream of the valve 114, around the valve 114, and downstream towards the channel 108 (as depicted in FIG. 2) and a closed position 118, in which molten plastic is prevented from flowing from downstream of the valve 114 and around the valve 114 (as depicted in FIG. 3). The valve 114 includes a valve proximal end 120, a valve distal end 122, and a first valve surface 124 at the valve proximal end 120. The valve 114 translates in the channel 108 in a lateral direction (e.g., along the x-axis as depicted in the coordinate axis of FIG. 2) such that the valve may translate from the open position 116 to the closed position 118. When the valve 114 is in the closed position 118, a seal 126 is formed between the first inlet surface 112 of the inlet 110 and the first valve surface 124 of the valve 114. The inlet 110 may also include an inlet diameter surface 131 or an inlet tapered surface 132 at the inlet distal end 113. Similarly, the valve 114 may include a valve diameter surface 133 or a valve tapered surface 134 at the valve proximal end 120, as will be described in additional detail herein.

Turning now to FIG. 2, the valve assembly 200 is depicted in the open position 116. The nozzle 103 may be fluidly coupled to the inlet proximal end 115, such that molten plastic flows through the inlet distal end 113 and into the channel proximal end 128. In the open position 116, the valve 114 may be positioned at the channel proximal end 128 or the channel distal end 130. In the open position 116, molten plastic may flow around the valve 114 in the lateral direction, such that molten plastic flows from the valve proximal end 120 to the valve distal end 122. As the molten plastic flows around the valve distal end 122, the molten plastic then flows through the channel proximal end 128 to the channel distal end 130 and into the manifold 106.

The channel 108 may include the channel proximal end 128 and the channel distal end 130. The channel proximal end 128 may be in fluid communication with the inlet 110 at the inlet distal end 113 and, thus, the channel proximal end 128 may be in fluid communication with the nozzle 103. The channel distal end 130 may be in fluid communication with the manifold 106. The molten plastic may flow downstream from the channel proximal end 128, through the channel 108, out through the channel distal end 130, and into the manifold 106. The manifold 106 may include a single outlet, or a plurality of outlets.

As the molten plastic flows downstream from the channel proximal end 128 through the channel 108, the molten plastic flows around the valve 114, such that the molten plastic flows from the valve proximal end 120 to the valve distal end 122. As more of the molten plastic flows around the valve 114, the differential pressure is generated between the channel proximal end 128 and the channel distal end 130. The differential pressure causes the valve 114 to translate from the open position 116 to the closed position 118.

The valve 114 is positioned within the channel 108 such that when a differential pressure is developed between the channel proximal end 128 and the channel distal end 130 causing a back pressure (i.e., in the upstream direction), the differential pressure causes the valve 114 to be translated from the channel distal end 130 to the channel proximal end 128 and, thus, from the open position 116 to the closed position 118. When the valve 114 is translated to the closed position 118, as depicted in FIG. 3, the seal 126 is formed.

Referring now to FIG. 3, the seal 126 is formed between the first inlet surface 112 of the inlet 110 and the first valve surface 124 of the valve 114. The seal 126 may prevent the molten plastic from escaping the inlet 110 when the nozzle 103 is uncoupled from the inlet proximal end 115 of the inlet 110.

The inlet 110 may further include the inlet diameter surface 131 at the inlet distal end 113, and the valve 114 may further include the valve diameter surface 133 at the valve proximal end 120. The inlet diameter surface 131 of the inlet 110 and the valve diameter surface 133 of the valve 114 may create a diameter seal when the valve 114 is translated from the open position 116 to the closed position 118. Thus, the seal 126 may include the diameter seal 126, such that, in the closed position, only the inlet diameter surface 131 of the inlet 110 and the valve diameter surface 133 of the valve are in contact, and the valve 114 does not extend into the inlet 110 beyond the valve diameter surface 133.

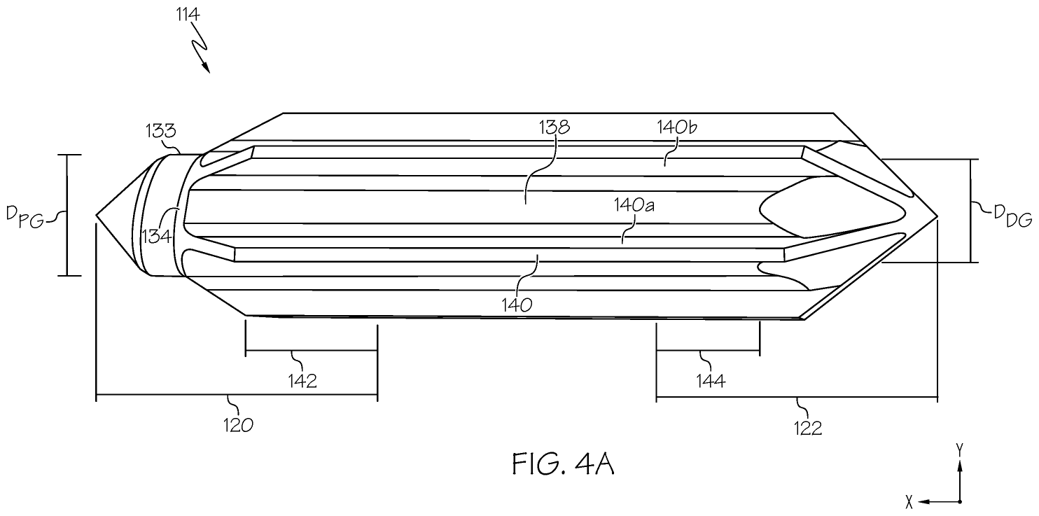

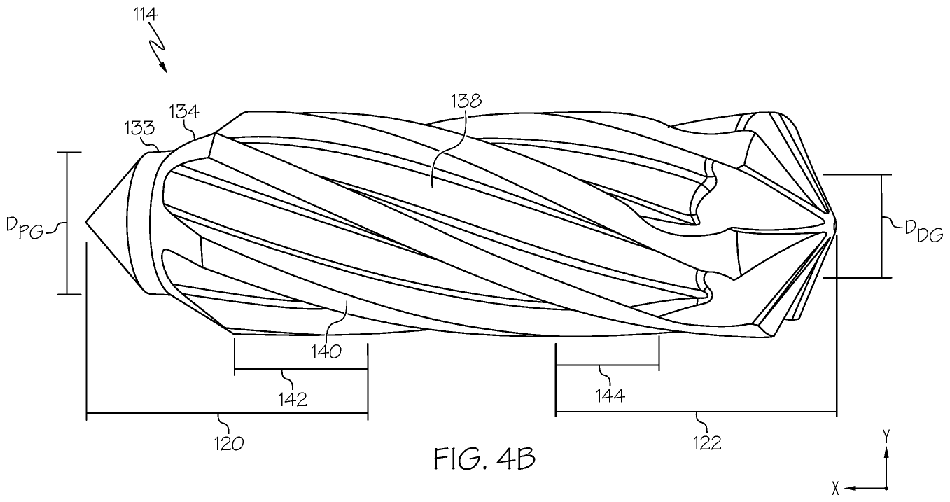

Referring again to FIG. 3, the inlet 110 may also include the inlet tapered surface at the inlet distal end 113. The valve 114 may include the valve tapered surface 134 at the valve proximal end 120. The inlet tapered surface 132 of the inlet 110 and the valve tapered surface 134 (see FIG. 4) of the valve 114 may create a taper seal when the valve 114 is translated from the open position 116 to the closed position 118. Thus, the seal 126 may include the taper seal. In some embodiments, the seal 126 between the inlet 110 and the valve 114 may include one, or both of the diameter seal 126 and the taper seal.

The first inlet surface 112 of the inlet 110 and the first valve surface 124 of the valve 114 may be circular. The size of the first inlet surface 112 may be the same size, or slightly smaller than the first valve surface 124, such that the first inlet surface 112 and the first valve surface 124 form the seal 126 when the valve 114 is in the closed position 118. The shape of the first inlet surface 112 and the first valve surface 124 often correspond. For example, the first inlet surface 112 and the first valve surface 124 may have the same shape, such that contact between the first inlet surface 112 and the first valve surface 124 forms a tight seal 126. The valve assembly 200 may further include an O-ring between the first inlet surface 112 of the inlet 110 and the first valve surface 124 of the valve 114. The O-ring may further prevent the molten plastic from escaping the inlet 110 when the nozzle 103 is uncoupled from the inlet 110.

A diameter of the channel 108 may range, for instance, from about 4 millimeters to about 40 millimeters, among other possibilities. Referring again to FIGS. 2 and 3, the channel 108 may be subject to pressures over about 1,000 pounds per square inch (about 7000 Kilopascals).

Referring again to FIG. 3, the valve assembly 200 is depicted in the closed position 118. In the closed position 118, the valve 114 is positioned at the channel proximal end 128. In the closed position 118, molten plastic is prevented from flowing around the valve 114 due to the diameter seal 126 between the first inlet surface 112 of the inlet 110 and the valve diameter surface 133 of the valve 114. As such, the molten plastic is prevented from flowing through the channel 108.

Referring now to FIG. 4A and FIG. 4B, the valve 114 may also include a plurality of fins 140. The plurality of fins 140 may be spaced out evenly, or in varying frequencies around the perimeter of the valve 114. For example, there may be six of the plurality of fins 140 spaced out evenly along the perimeter of the valve 114, such that the six plurality of fins 140 are sixty degrees apart.

In these embodiments, the valve 114 may further include a plurality of grooves 138. In embodiments, in which the valve 114 includes six of the plurality of fins 140, the plurality of grooves 138 may be defined between each set of the plurality of fins 140, such that the valve 114 includes six grooves 138.

Turning now to the exemplary embodiment depicted in FIG. 4A, the valve 114 may further include at least one fin 140 and at least one groove 138 extending from the valve proximal end 120 to the valve distal end 122. The valve 114 may include a first fin 140a and a second fin 140b. In these embodiments, a plurality of grooves 138 may be defined between the first fin 140a and the second fin 140b, and may extend from the valve proximal end 120 to the valve distal end 122. The plurality of grooves 138 permits the molten plastic to flow through the plurality of grooves 138 from the valve proximal end 120 to the valve distal end 122, as will be described in additional detail herein.

Referring still to FIG. 4A, the plurality of grooves 138 may also include a groove proximal end 142 and a groove distal end 144. The groove proximal end 142 may have a groove proximal diameter D_{PG}, and the groove distal end 144 may have a groove distal diameter D_{DG}. The groove proximal diameter D_{PG} may be larger than the groove distal diameter D_{DG}. In some embodiments, the groove distal diameter D_{DG} may be larger than the groove proximal diameter D_{PG}.

The valve 114 may be sized such that the valve 114 has a torpedo shape, as depicted in FIG. 4A and FIG. 4B. The torpedo shape may be defined by a valve length in the lateral direction (e.g., along the x-axis as depicted in the coordinate axis of FIG. 4A and FIG. 4B) being greater than a valve diameter in the longitudinal direction (e.g., along the y-axis as depicted in the coordinate axis of FIG. 4A and FIG. 4B). The torpedo shape of the valve 114 with the plurality of fins 140 and plurality of grooves 138 help direct the molten plastic from the valve proximal end 120 to the valve distal end 122 due to the plurality of grooves 138 being directed in the lateral direction. The valve 114 with the torpedo shape may also have the valve diameter surface 133 and the valve tapered surface 134.

Turning now to the exemplary embodiment depicted in FIG. 4B, the plurality of fins 140 may be helical. As such, the plurality of grooves 138 may also be helical. The plurality of grooves 138 as helical grooves also help direct the molten plastic from the valve proximal end 120 to the valve distal end 122. The embodiment depicted in FIG. 4B may also have the valve diameter surface 133 and the valve tapered surface 134.

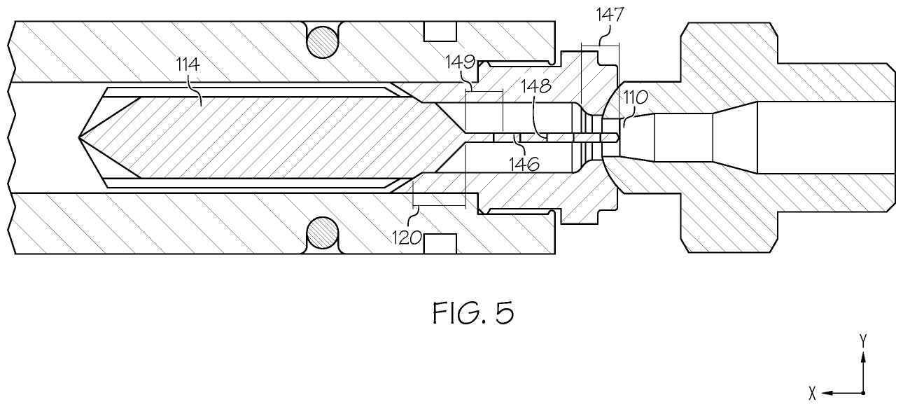

Turning now to FIG. 5, in some embodiments, the valve 114 may further include a tail 146. The tail 146 may have a proximal tail end 147 and a distal tail end 149. The distal tail end 149 may be integrated into the valve 114 at the valve proximal end 120. The distal tail end 149 may be manufactured as part of the valve 114, or mechanically coupled to the valve 114, such as through welding, brazing, adhesive, or a threaded engagement. The tail 146 may also include a plurality of markers 148.

The plurality of markers 148 of the tail 146 may act as an indicator to an operator of the valve assembly 200 that the valve proximal end 120 of the valve 114 is approaching the inlet 110. In these embodiments, the proximal tail end 147 is dispensed from the inlet 110 before the seal 126 is formed, which indicates to the operator that the valve proximal end 120 of the valve is approaching the inlet 110. The plurality of markers 148 indicate to the operator a position of the valve 114 within the channel 108. For example, as the valve 114 is translated from the open position 116 to the closed position 118, the tail 146 may protrude from the inlet 110; the plurality of markers 148 on the tail 146 may indicate to the operator that the valve proximal end 120 and the first valve surface 124 is 1 centimeter, 2 centimeters, 5 centimeters, or any other suitable length from the inlet 110. The plurality of markers 148 indicates to the operator the position of the first valve surface 124 of the valve 114 relative to the first inlet surface 112 of the inlet 110, such that the operator may determine whether the seal 126 has been formed between the first valve surface 124 and the first inlet surface 112.

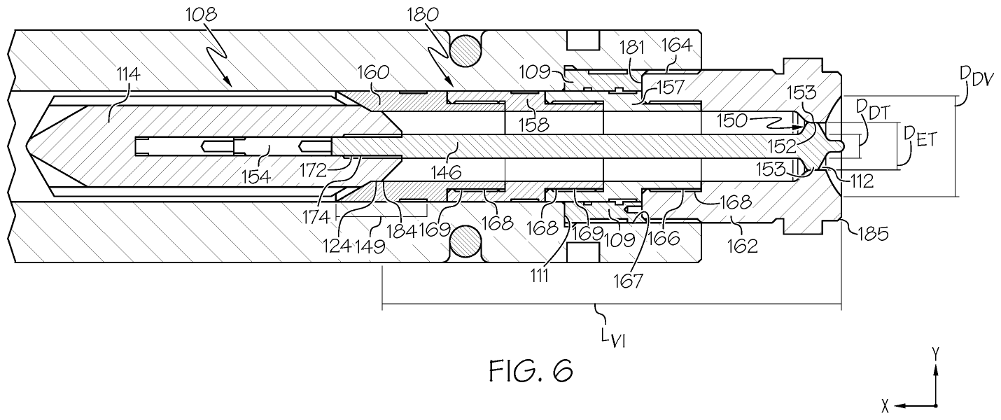

Referring now to FIG. 6, in some embodiments the tail 146 has a tail diameter D_{DT} less than a valve diameter D_{DV}. The tail 146 may also include an enlarged tail portion 150. The enlarged tail portion 150 may have a diameter D_{ET} greater than the tail diameter D_{DT}. The enlarged tail portion 150 may include a tail surface 152. The tail surface 152 may create a tail seal 153 between the tail surface 152 and the first inlet surface 112 of the inlet 110. The tail seal 153 may include the diameter seal.

Referring again to FIG. 6, the valve 114 may further include a hollow recess 154 positioned within the valve proximal end 120. The hollow recess 154 may include a hollow recess threaded surface 172. Moreover, the distal tail end 149 may include a tail threaded surface 174. The hollow recess threaded surface 172 and the tail threaded surface 174 may threadingly engage one another to connect the tail 146 to the valve 114. Thus, the hollow recess 154 and hollow recess threaded surface 172 allow for the valve 114 to be used in valve assemblies 200 of differing dimensions.

The valve assembly 200 may further include an adapter 162, which may include an inner adapter threaded surface 166, and a plurality of spacers 180. The plurality of spacers 180 may each include a proximal threaded surface 168 and a distal threaded surface 169. Any number of the plurality of spacers 180 may be threadingly engaged and positioned between the first valve surface 124 of the valve 114 and the first inlet surface 112 of the inlet 110 in order to increase the length L_{VI} between an end 184 of the first valve surface 124 and an end 185 of the adapter 162 when the valve 114 is in the closed position 118.

For example, FIG. 6 depicts an exemplary embodiment of the valve assembly 200 having the plurality of spacers 180 and a filler 109. As depicted, the plurality of spacers 180 includes a first spacer 157, a second spacer 158, and a third spacer 160. Moreover, the filler 109 may be positioned at the channel proximal end 128. The filler 109 may fill a gap between an end 181 of the adapter 162 and a channel shoulder 111. The channel 108 may include a threaded surface 167, which may be configured to threadingly engage an outer adapter threaded surface 164 of the adapter 162.

As further depicted in FIG. 6, the first spacer 157 may be positioned at the channel proximal end 128 and may include the proximal threaded surface 168, which may be configured to threadingly engage the inner adapter threaded surface 166, such that the length L_{VI} may be increased. The second spacer 158 may also be positioned within the channel 108. The proximal threaded surface 168 of the second spacer 158 may threadingly engage the inner adapter threaded surface 166, such that the length L_{VI} may be increased. To further increase the length L_{VI} when the valve 114 is in the closed position 118, the proximal threaded surface 168 of the second spacer 158 may threadingly engage the distal threaded surface 169 of the first spacer 157. The proximal threaded surface 168 of the third spacer 160 may threadingly engage the inner adapter threaded surface 166, such that the length L_{VI} may be increased. To further increase the length L_{VI}, the proximal threaded surface 168 of the third spacer 160 may threadingly engage the distal threaded surface 169 of the second spacer 158, as depicted in FIG. 6.

Although the valve assembly 200 of FIG. 6 is depicted as including three spacers, it should be appreciated that the valve assembly 200 may include any number of the plurality of spacers 180 without departing from the scope of the present disclosure. For example, the valve assembly 200 may include a single spacer, two spacers, four spacers, six spacers, or any other number of spacers. As has been described herein, increasing the number of the plurality of spacers 180 positioned within the valve assembly 200 may act to increase the length L_{VI}. In contrast, decreasing the number of the plurality of spacers 180 positioned may decrease the length L_{VI}. Furthermore, in some embodiments, it should be understood that the valve assembly may not include the plurality of spacers 180 (as depicted in FIG. 5).

In some embodiments, a method of delivering molten plastic is described. The method may include coupling the nozzle of the injector to the first inlet surface of the inlet, injecting the molten plastic into the channel through the nozzle, and translating the molten plastic from the channel proximal end to the channel distal end. The method further includes translating the valve from the open position to the closed position and sealing the inlet through the seal between the first inlet surface of the inlet and the first valve surface of the valve.

In view of the foregoing, it should be understood that the present disclosure relates to an injection molding system including an injector, a nozzle, a manifold, and a valve assembly for an injection molding system. The valve assembly may include an inlet that receives the nozzle. The nozzle injects molten plastic into a channel through the inlet. As the molten plastic translates from a channel proximal end to a channel distal end, the molten plastic flows a cross a perimeter of a valve. A differential pressure may build between the channel proximal end and the channel distal end, causing the valve to translate between an open position to a closed position. In the closed position, the valve creates a seal with the inlet. The seal prevents the molten plastic from escaping the inlet upon the differential pressure building between the channel proximal end and the channel distal end.

What is claimed is:

1. A valve assembly for an injection molding system, the valve assembly comprising:
a channel comprising a channel proximal end and a channel distal end;
an inlet comprising a first inlet surface at an inlet distal end fluidly coupled to the channel at the channel proximal end, wherein the inlet couples to a nozzle at an inlet proximal end for injecting a molten plastic into the channel; and
a valve translatably coupled to the channel, wherein the valve translates between an open position and a closed position, the valve comprising:
a valve proximal end;
a valve distal end; and
a first valve surface at the valve proximal end;
wherein a diameter seal is formed between the first inlet surface of the inlet and the first valve surface of the valve when the valve is in the closed position.

2. The valve assembly of claim 1, wherein:
the inlet further comprises an inlet diameter surface at the inlet distal end; and
the valve further comprises a valve diameter surface at the valve proximal end, wherein:
the inlet diameter surface of the inlet and the valve diameter surface of the valve create the diameter seal when the valve is in the closed position.

3. The valve assembly of claim 1, wherein:
the inlet further comprises an inlet tapered surface at the inlet distal end; and
the valve further comprises a valve tapered surface at the valve proximal end, wherein:
the inlet tapered surface of the inlet and the valve tapered surface of the valve create a taper seal when the valve is in the closed position.

4. The valve assembly of claim 2, wherein:
the inlet further comprises an inlet tapered surface at the inlet distal end; and
the valve further comprises a valve tapered surface at the valve proximal end, wherein:
the inlet tapered surface of the inlet and the valve tapered surface of the valve create a taper seal when the valve is in the closed position.

5. The valve assembly of claim 1, wherein the valve further comprises at least one fin and at least one groove extending from the valve proximal end to the valve distal end.

6. The valve assembly of claim 1, wherein the valve further comprises a tail on the valve proximal end extending towards the inlet proximal end.

7. The valve assembly of claim 6, wherein the tail is labeled with a plurality of markers corresponding to a position of the valve from the open position to the closed position.

8. The valve assembly of claim 6, wherein the tail includes an enlarged tail portion with a tail surface, wherein the tail surface creates a tail seal between the first inlet surface of the inlet and the tail surface of the enlarged tail portion of the tail.

9. The valve assembly of claim 6, further comprising:
a hollow recess positioned within the valve proximal end, wherein the hollow recess comprises a hollow recess threaded surface; and
a tail threaded surface at a distal tail end;
wherein the hollow recess threaded surface and the tail threaded surface threadingly engage to connect the tail to the valve.

10. The valve assembly of claim 6, further comprising:
an adapter, wherein the adapter comprises an inner adapter threaded surface; and
a plurality of spacers, wherein each of the plurality of spacers comprise a proximal threaded surface and a distal threaded surface;
wherein the inner adapter threaded surface and the proximal threaded surface of a most proximal spacer threadingly engage to increase the length between the first valve surface of the valve and the first inlet surface of the inlet when the valve is in the closed position.

11. The valve assembly of claim 6, further comprising:
an adapter, wherein the adapter comprises an inner adapter threaded surface;
a first spacer at the channel proximal end, wherein the first spacer comprises a proximal threaded surface and a distal threaded surface; and
a second spacer, wherein the second spacer comprises the proximal threaded surface;
wherein the proximal threaded surface of the first spacer and the inner adapter threaded surface threadingly engage to increase a length between the first valve surface of the valve and the first inlet surface of the inlet when the valve is in the closed position, and the distal threaded surface of the first spacer and the proximal threaded surface of the second spacer threadingly engage to further increase the length between the first valve surface of the valve and the first inlet surface of the inlet when the valve is in the closed position.

12. The valve assembly of claim 1, wherein the first inlet surface of the inlet and the first valve surface of the valve are circular in cross-section.

13. The valve assembly of claim 1, wherein the valve is a torpedo valve.

14. A injection molding system comprising:
a manifold comprising a channel comprising a channel proximal end and a channel distal end;
an plastic injector comprising a nozzle;
an inlet comprising a first inlet surface at an inlet distal end fluidly coupled to the channel at the channel proximal end, wherein the inlet couples to the nozzle at an inlet proximal end that injects a molten plastic into the channel; and
a valve translatably coupled the channel, wherein the valve translates between an open position and a closed position, the valve comprising:
at least one groove;
at least one fin;
a valve proximal end;
a valve distal end; and
a first valve surface at the valve proximal end;
wherein the valve translates from the open position to the closed position and a diameter seal is formed between the first inlet surface of the inlet and the first valve surface of the valve.

15. The injection molding system of claim 14, wherein:
the inlet further comprises an inlet diameter surface at the inlet distal end; and
the valve further comprises a valve diameter surface at the valve proximal end, wherein:
the inlet diameter surface of the inlet and the valve diameter surface of the valve create the diameter seal when the valve translates from the open position to the closed position.

16. The injection molding system of claim 14, wherein:
the inlet further comprises an inlet tapered surface at the inlet distal end; and
the valve further comprises a valve tapered surface at the valve proximal end, wherein:
the inlet tapered surface of the inlet and the valve tapered surface of the valve create a taper seal when the valve translates from the open position to the closed position and the molten plastic moves through the channel.

17. The injection molding system of claim 16, wherein:
the inlet further comprises an inlet tapered surface at the inlet distal end; and
the valve further comprises a valve tapered surface at the valve proximal end, wherein:
the inlet tapered surface of the inlet and the valve tapered surface of the valve create a taper seal when the valve translates from the open position to the closed position and the molten plastic moves through the channel.

18. The injection molding system of claim 14, wherein the molten plastic can move between the at least one groove of the valve.

19. The injection molding system of claim 14, wherein the valve is a torpedo valve.

20. The injection molding system of claim 14, wherein the valve further comprises a tail on the valve proximal end to indicate whether the valve is in the open position or the closed position.
